(19) United States
(12) Patent Application Publication
(10) Pub. No.: US 2020/0211080 A1
(43) Pub. Date: Jul. 2, 2020

(54) CODE SHARING IN E-COMMERCE

(71) Applicant: eBay Inc., San Jose, CA (US)

(72) Inventors: Gail Anna Rahn Frederick, Portland, OR (US); Tatjana Vlahovic, San Jose, CA (US)

(21) Appl. No.: 16/235,633

(22) Filed: Dec. 28, 2018

(51) Int. Cl. G06Q 30/06; G06F 16/9532

(52) U.S. Cl. CPC G06Q 30/0625; G06F 16/9532

(57) ABSTRACT

Described are computing systems and methods, computer program products, and application programming interfaces (APIs) or web requests that facilitate code sharing between operators of e-commerce platforms. In accordance with various embodiments, a codeshare principal shares its inventory and other functionality with a codeshare partner to thereby expand its customer base. Requests from the partner to the principal include identifiers of the partner as well as the partner's user, allowing the principal to track its extended customer base and tailoring responses to the partner and the user.

### TECHNICAL FIELD

The present disclosure relates to computing systems and methods, computer program produces, and application programming interfaces (APIs) that facilitate code sharing between multiple electronic marketplaces, web sites, or any other commercial actors or e-commerce platforms.

### BACKGROUND

Code sharing—a term used by the airline industry—involves the cross-marketing of products or services between two or more providers (e.g., merchants, companies, etc.) pursuant to some contractual business arrangement. For example, two airlines may both list the same flight (operated by one of them), each under their own respective airline flight code. By cross-listing each other's flights using code sharing, airlines operating flights between the same departure and destination airports can increase the perceived frequency of service along that route; airlines operating different ones of two connecting flights can provide clearer routing for their customers; and airlines servicing different geographic regions can gain exposure in the respective markets in which they do not themselves operate. An opportunity exists to consider technical ways of integration of this paradigm to other platforms and sites.

### BRIEF DESCRIPTION OF THE DRAWINGS

The appended drawings illustrate, by way of example and not of limitation, various embodiments of systems, methods, and computer program products implementing the inventive subject matter.

FIG. 1 is a block diagram illustrating actors within a code sharing ecosystem according to example embodiments.

FIG. 2 is a block diagram illustrating communications between the actors within a code sharing ecosystem according to example embodiments.

FIG. 3 is a flow chart depicting various acts performed by a codeshare partner to share user behavioral data with a codeshare principal, in accordance with various embodiments.

FIG. 4 is a process flow diagram depicting the transactional flow of a two-buyer transaction in accordance with various embodiments.

FIG. 5 is a process flow diagram depicting a partner-mediated informational flow between a codeshare partner and an end customer in accordance with various embodiments.

FIG. 6 is a flow chart of an example method performed by a codeshare principal in tailoring its response to a request based on user preferences, in accordance with various embodiments.

FIG. 7 is a schematic diagram illustrating sources of user and partner behavioral data, in accordance with various embodiments.

FIG. 8 is a block diagram illustrating software components of a codeshare principal's server system in accordance with various embodiments.

FIG. 9 is a diagrammatic representation of a machine in the example form of a computer system within which a set of instructions for causing the machine to perform any one or more of the methodologies discussed herein may be executed.

### DETAILED DESCRIPTION

In the following description, reference will be made to specific example embodiments for carrying out the inventive subject matter. Examples of these specific embodiments are illustrated in the accompanying drawings. It will be understood that these examples are not intended to limit the scope of the claims to the illustrated embodiments. On the contrary, they are intended to cover alternatives, modifications, and equivalents as may be included within the scope of the disclosure. In the following description, specific details are set forth in order to provide a thorough understanding of the subject matter. Embodiments may be practiced without some or all of these specific details.

The present disclosure relates to various technical aspects of implementing code sharing arrangements. For clarity, various embodiments are described from the perspective of a primary actor, herein the “codeshare principal,” that offers its products and/or services through one or more codeshare partners. It is to be understood, however, that codeshare arrangements may be (although they need not be) reciprocal, allowing the roles of codeshare principal and codeshare partner to be reversed between a given pair of codeshare parties. In various embodiments, the codeshare principal provides a platform that exposes certain functionalities to its codeshare partner(s) and their respective platforms. Without limitation, such functionalities may include inventory feeds and inventory checks, transactional functions for payment and shipping arrangements, and/or search and discovery features, for example. A “platform,” as understood herein, may be or include a server, web site, mobile app, voice interface, phone ordering system, or other technical implementation. In some embodiments, the codeshare principal's platform is implemented by a server (including one or more server computers), operated by, on behalf, and/or under the control of the codeshare principal, that exposes some of the principal's functionality, e.g., via a web site and/or one or more APIs (e.g., web APIs). As an example, AMAZON, ETSY, ALIIBABA, or others could integrate code sharing to a web site to enhance partner integration. Equally, this technique may be used by web search providers such as a GOOGLE site in conjunction with web search offerings, a NETFLIX site in relation to media offerings, etc. The codeshare partners can access this functionality via (e.g., API) requests to the server.

Code sharing may be particularly suited to e-commerce platforms. For instance, an online seller prevented from directly transacting with end customers in a certain geographic region can gain marketing exposure to those end customers by partnering with a seller operating in that geographic region, channeling merchandize through the partner. Similarly, a boutique offering one type of merchandize (e.g., dresses) may complement its offering by cross-listing and purchasing merchandize in related product categories (e.g., jewelry, accessories) from a partner for resale to its own customers. Thus, code sharing arrangements allow a provider to effectively expand its customer base through transactions mediated via a codeshare partner.

The code sharing techniques described herein confer various technical advantages to computers and data centers using them. For example, by allowing use of a code sharing identifier, the number of items may be filtered or reduced. This improves network bandwidth because less data is sent, and it improves the efficiency of processors because less data is processed. Still further, less memory, storage need be used in processing fewer items.

Still further, by gathering data, such as behavioral data, associated with a partner and/or a user, there is a technical advantage of improved data accuracy in presentation of items for a user. For example, by automatically determining interests based on behavioral interaction with a web site or other platform, it is more likely that a user will find an item being sought efficiently and quickly, and more likely that a user does not select a non-optimal item. It follows, of course, that if the user is more efficient in selection of an item, fewer processor cycles and computational resources are used in processing results.

In addition, the code sharing techniques described herein include use of device fingerprints. The use of fingerprints, which are not easy to spoof, confer a technical advantage to systems by improving the security and integrity of transactions. Use of device fingerprints of a user device, or partner device, may improve security of systems. By including various details of systems, including hardware details, operating system, application install details, a fingerprint becomes very difficult to spoof.

APIs are, conceptually, software intermediaries that allow two software applications to communicate with each other. In general, APIs may take the form of specifications and/or software implementations of routines, classes, class methods, communication protocols, and the like that expose components of the API provider's software system and functionality in well-documented services to internal, external partner, or anonymous developers. Web APIs, in particular, usually include a set of specifications for request messages along with the definition and structure of response messages that facilitate interactions between a server and client applications using its assets. In the context of code sharing as discussed herein, APIs provide specifications that enable applications executing on a partner's computing system to interface with and utilize some of the software-implemented functionality of the principal's server.

Code sharing in accordance with various embodiments goes beyond conventional codeshare arrangements by facilitating and taking advantage of information sharing about end customers (with the end customers' and partners' authorization, as described further below). For example, a codeshare partner may, in addition to facilitating an indirect transaction between an end customer and a codeshare principal (e.g., mediating a purchase of a product or service by the end customer from the codeshare principal), pass on information about that end customer to the principal. The information may include at least a unique identifier of the end customer that persists across repeat transactions or requests involving the same end customer, enabling the codeshare principal to properly attribute requests and transactions to individuals (although the real-world identities of these individuals may remain hidden) and thereby obtain an accurate count of its complete customer base and recognize, e.g., new or returning customers. The information shared with the codeshare principal may also include user behavioral data, such as browsing and/or purchase histories recorded by the codeshare partner. Recording and aggregating request/transactions attributable to and/or behavioral or other additional data about a given end customer can give the codeshare principal the ability to tailor its response to subsequent requests to the end customer.

Apart from information about individual end customers, the codeshare partner may also transmit statistical or aggregate behavioral data about its customers and/or data about its own activities, such as one or more categories of products/services offered by the codeshare partner, sales data for items within the category and for items outside the category, and/or marketing data about a presentation of item listings the codeshare partner received from the codeshare principal. With permission and consent received, partner behavioral information may also be recorded, such as commonly queried categories of interest from a partner, or frequently browsed items from a partner site (or other partner platform), etc. Such information may be recorded by the codeshare principal in association with a unique identifier of the codeshare partner, and used to tailor the codeshare principal's responses to requests received from the codeshare partner.

In various embodiments, to facilitate the above-described information sharing, each request from a codeshare partner to the codeshare principal's server may include a unique identifier of the codeshare partner (hereinafter also the “code sharing identifier”), a unique identifier of the end customer (or end user) on behalf of which the codeshare partner makes the request (herein also the “user identifier”), or both. The code sharing identifier may be assigned to the codeshare partner in the course of setting up the code sharing arrangement. The user identifier may be based, e.g., on an email address, telephone number, or device fingerprint of an electronic device used by the end customer, which may be used in encoded form to protect the end customer's identity. The codeshare principal can use the code sharing identifiers and user identifiers to track and aggregate requests and transactions per partner and per user, e.g., by creating or updating partner and user data records associated with the respective identifiers based on requests or transactions. Further, subsequent to the first request including a particular user identifier and code sharing identifier, content sent by the codeshare principal in response to further requests including the same user identifier and/or code sharing identifier can be determined based on the respective user data record and/or partner data record.

In one embodiment, a method performed by a codeshare principal's server system (e.g., by one or more processors of the server system that execute instructions stored in a computer-readable medium) involves receiving a request that includes a code sharing identifier associated with a partner, a user identifier, and a user query criterion, and, in response to the request, determining a category associated with the code sharing identifier, determining an item within the category based on a preference associated with the user identifier and the user query criterion, and returning the item in a response to the request. The item within the category may be determined by determining, based on the preference associated with the user identifier and the user query criterion, two or more items at least one of which is associated with the category and at least one of which is not associated with the category, and selecting, among the two or more items, an item associated with the category. The response may include a ranking or recommendation of one or more items based on the code sharing identifier, and optionally further based on the user identifier.

The method may further include receiving, prior to the request, a call that includes user behavioral data about a user associated with the user identifier, the user behavioral data collected at a partner platform (e.g., a partner site) associated with the code sharing identifier, wherein the preference associated with the user identifier is based at least in part on the user behavioral data; the user behavioral data may include any one of user click data, user telemetry data, and/or user browse data on the partner platform. Alternatively or additionally, the method may include receiving, prior to the request, a call that includes partner behavioral data about the partner associated with the code sharing identifier, wherein the item within the category is determined further based on the partner behavioral data; the partner behavioral data may include any one of aggregate behavioral data about multiple users on a partner platform, marketing data about a presentation of items received by the partner from the server system the partner platform, or partner sales data for items within the category and for items outside the category.

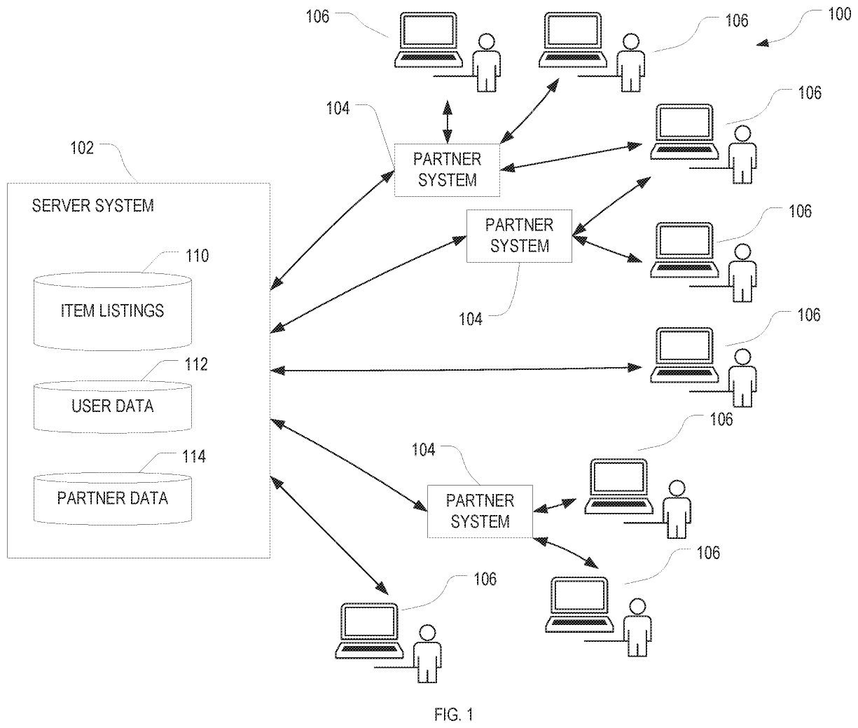

With reference now to the accompanying drawings, FIG. 1 illustrates, in block-diagram form, a code sharing ecosystem 100 according to example embodiments. Within the ecosystem 100, a server system 102 can interact, via the internet or some other suitable communications network (not shown), with one or more partner systems 104, which may, in turn, be accessed by one or more end users' client devices 106. Additionally, the server system 102 may interact directly with some end users via their client devices 106. For purposes of the following discussion, the server system 102 is operated by, on behalf, or under the control of a codeshare principal, whereas the partner systems 104 are operated by, on behalf, or under the control of respective codeshare partners.

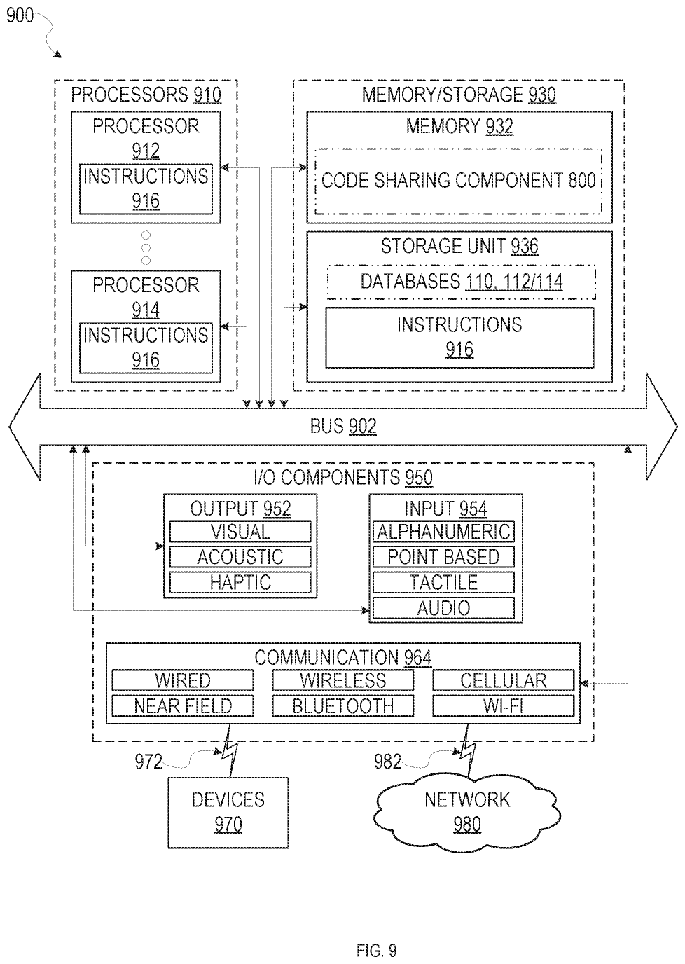

The server and partner systems 102, 104 as well as the client devices 106 are implemented by suitable computing hardware including one or more computer processors, which may generally include any combination of general-purpose processors configured by program code stored in computer-readable media to perform the functionality described herein and/or hardwired or otherwise permanently configured special-purpose processors. In various embodiments, the server system 102 includes either a single server computer or multiple server computers communicating with each other via a suitable wired or wireless network, such as, for example and without limitation, a local area network (LAN) established by Ethernet cable or Wi-Fi connections between computers, or a wide area network (WAN), such as the internet, utilizing telephone lines, radio wave transmission, or optical fiber connections. Each of the one or more computers within the server system 102 may be implemented, e.g., with a machine 900 as described in more detail below with reference to FIG. 9. The partner systems 104 may likewise each be implemented by one computer or multiple computers intercommunicating via a network, and each computer may be similar to the machine 900. Functionally, the partner systems 104 play the role of servers in relation to the client devices 106, but constitute clients vis-à-vis the server system 102. The client devices 106 employed by the end users are usually (although not necessarily) personal computers, such as desktop or laptop computers, tablets, smartphones, or the like. The server system 102, partner systems 104, and client devices 106 all include network interfaces to facilitate communications between them.

In accordance with various embodiments, the server system 102 may operate an e-commerce platform that lists products, services, and/or real estate available for purchase, rent/lease, auction, ordering, or reservation via online transactions. Equally, the server system 102 may implement search services such as search, digital media consumption, etc. In one embodiment, the codeshare principal may maintain a physical inventory of listed products, e.g., stored in warehouses operated by the codeshare principal, and/or may act simply as a sales intermediary for products offered by third-party sellers. Such third-party sellers may include commercial entities such as manufacturers, distributers, and retailers, as well as individual seller-users that list items on the e-commerce platform. Similarly, the providers of listed services may be employees of the codeshare principal, independent contractors, or unaffiliated third-party providers that use the e-commerce platform as a referral system. For each item listed, the server system 102 may store, e.g., in an item listings database 110, a unique item identifier along with an item description (including, e.g., a name/title, longer textual description or specification, one or more images) and price, and, optionally, seller/provider information, shipping options, customer reviews, or other pertinent information. The item listings are herein collective also referred to as the codeshare partner's “inventory.”

Examples of products that may be offered on the site-commerce platform include consumer products (such as, e.g., apparel, vehicles, toys, or consumer electronics) as well as industrial merchandize (such as, e.g., raw materials or device components). Examples of services include pure labor or professional services (such as, e.g., babysitting or accounting) as well as service tied to goods (e.g., landscaping, catering) or to the use of venues or facilities (e.g., flights, hotel accommodations), and may likewise be offered to private as well as business customers. Real estate may include, e.g., homes or vacation properties. As will be apparent from these examples, the terms “electronic site,” “products and/or services,” “item listings,” are intended to be accorded broad scope as to the specific applications they cover. Further, where the following description refers to a “purchase,” “sale,” or the like, it is to be understood that, unless otherwise indicated or clear from context, other transaction types (e.g., rent/lease, reservation, etc.) are also contemplated.

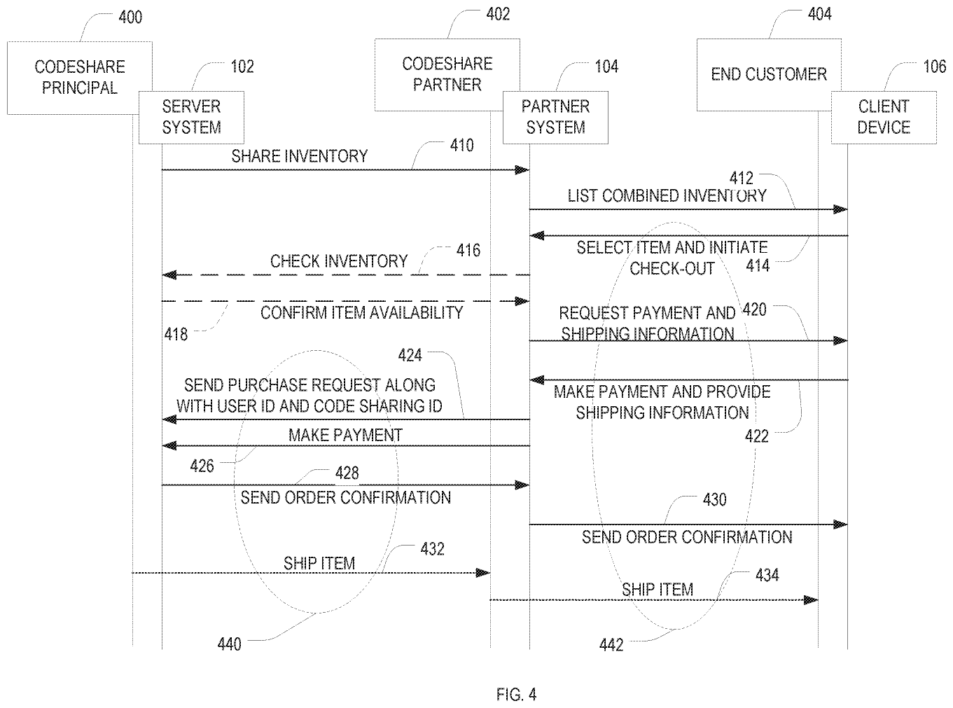

The e-commerce platform operated by the server system 102 may be accessed by end users (e.g., via client devices 106), who can directly purchase items (or place bids for items in an auction setting) on the platform. In addition, in accordance with various embodiments, partners 104, which may operate their own respective e-commerce platforms, can retrieve at least a portion of the inventory from the item listings database 110 of the server system 102 for integration into their own listings. End users can then transact for items from the codeshare principal's inventory with the partner system 104, which can, in turn, obtain the items on behalf of its customers from the principal using the server system 102. In this manner, the codeshare partners can round out and expand their offerings, while the codeshare principal gains access to the partners' customers. Details of such two-buyer transactions, in which the partner acts as the direct buyer and the end user constitutes an indirect buyer, are described below with respect to FIG. 4.

In addition to channeling sales through its partners, the code share principal can also enable the partners' systems 104 to enhance the user experience on their own respective platforms, and thereby possibly drive sales, by providing search and discovery tools for products/services the end user may be interested in. For example, instead of or in addition to pulling inventory information from the server system 102 upfront, a partner system 104 may send, based on a search query or other input from one of its users, a specific search request to the server system 102, and the server system 102 may respond with one or more listings identified within its inventory based on the request. Further, in response receipt, at the server system 102, of a search or purchase request sent by the partner system 104 on behalf of its user, the server system 102 may send recommendations for additional items of potential interest, e.g., as determined from statistical user purchase behavior (such as a determination that users who viewed or purchased one kind of item also displayed interest in another item, or an identification of best-selling items). In accordance with various embodiments, such search results, recommendations, and the like may be tailored to specific users and/or to characteristics of the codeshare partner. To facilitate tailored responses, the server system 102 may gather user data and partner data from the partner systems 104 (with consent) and store them as data records associated with unique user identifiers and/or code sharing identifiers in respective databases 112, 114. In various embodiments, each request sent by a partner system 104 for a particular user includes the respective user identifier and code sharing identifier, enabling user and partner behavior to be tracked by the server system 102 across transactions and communications.

One application of code sharing involves a codeshare partner operating in a particular niche market that may wish to complement its offerings by listing related products or services, and a codeshare principal interested in meeting the partner's need to thereby gain exposure to the partner's customers. For instance, a women's clothing boutique may also want to offer is customers shoes, jewelry, and/or other accessories that complement the apparel it sells. For this purpose, the boutique may obtain item listings in the shoes, jewelry, and accessories categories from the codeshare principal and incorporate them into its own online store, e.g., matching up items of clothing provided by the partner with complementary items available from the principal. The boutique's customer can then purchase both types of items through the boutique. In some instances, the customer may buy all items online. In other situations, the customer may buy the boutique's core merchandize (e.g., clothing) physically in a brick-and-mortar store, and order the complementary item(s) on the store's website, mobile app, voice interface, phone ordering system, etc. The customer may, for instance, connect to the store's website, e.g., through a mobile application on her own device 106, while visiting the physical store. Alternatively, the store may have (store-owned) computer terminals, tablets, or the like available for its customers to use for the purpose of accessing its website. That is, a user may, in some circumstances, interact directly with the partner system 104 via user input/output devices, rather than indirectly over a network via a client device 106 owned by the user.

To provide yet another example that also covers the services sector, a codeshare principal may provide an online wedding planning platform that lists venues available for rental, caterers, musicians and other entertainment services, florists available for hire and/or specific flower arrangements available for purchase, wedding gowns, wedding rings, etc. To advertise its offerings and increase its market share, the codeshare principal may partner up with local venues, florists, caterers, and so on, which can integrate products and service listings in categories they do not themselves service to provide their customers with a one-stop shopping experience.

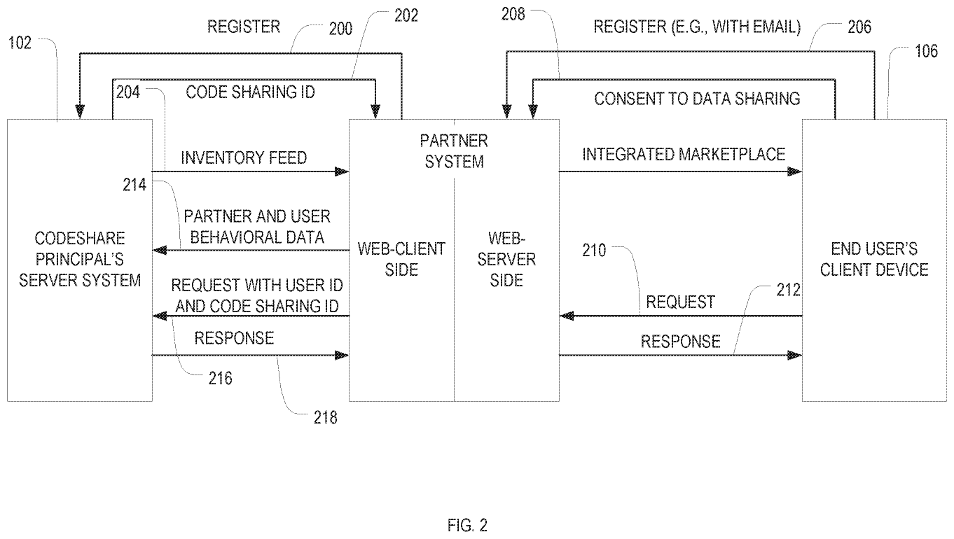

Turning now to FIG. 2, the communications between a codeshare principal, codeshare partner, and end user in accordance with various embodiments are illustrated in more detail. As shown, the partner system 104 may interact with the principal's server system 102 via web-client components, and with the end user's client device 106 via web-server components.

To facilitate interactions between the code-sharing parties, the partner system 104 is registered, at 200, with the principal's server system 102. The registration may involve setting up a partner profile that may specify, e.g., contact information (e.g., a corporate address, email and phone number of a liaison managing the code-sharing relationship), the partner's geographic market and/or area of business (including, e.g., categories of products or services the partner offers), categories of product or service listings that the partner is interested in receiving from the principal, expected sales volume of the principal's inventory on the partner system, financial account information (for the purpose of facilitating payments between the parties), etc. The registration may also include downloading application plug-ins, libraries, or other software components from the server system 102 to the partner system 104 to support various functionalities associated with the code-sharing arrangement. Further, in the course of the registration, the server system 102 may assign and communicate a code sharing identifier (code sharing ID) to the partner system 104 at 202. Alternatively, the code sharing ID may have been provided to the partner during the preceding establishment of contractual relations between the party, and may be entered by the partner during the registration of the partner system. Either way, in subsequent communications between the server system 102 and the partner system 104, the partner can identify itself by including the code sharing ID in its messages. Following registration, the partner system 104 may, at 204, receive inventory feeds, which may be tailored based on the partner profile, e.g., to include only listings within the specified categories of interest. The partner system 104 may merge these listings with other (e.g., its own) listings into an integrated listing on the partner's e-commerce platform.

On the other side of the partner system, certain interactions with the end user may be enabled by a user registration process at 206. As part of this process, the user may, e.g., create a username and password (or set up other authentication credentials), provide an email or telephone number (or similar personal information), and/or volunteer information concerning the user's interests and preferences, or other information that may enable the partner system to customize its communications to the user. To permit data sharing about the end user between the codeshare partner and principal in accordance herewith, the user registration process also involves obtaining, at 208, the user's affirmative consent to such information sharing. A request for consent may be made in conjunction with presenting the user with, and asking for his acknowledgement of, the partner's privacy policy and/or any applicable privacy laws. Prior to and/or along with being asked to allow information sharing with a third party (e.g., in this case, the codeshare principal), the user may also be informed that the partner system 104 would like to track the user's interactions with the partner's website or other platform (e.g., for the purpose of customizing dynamic website portions and/or improving the user experience) and asked for his affirmative consent to such tracking. Absent the requested consent, the user's actions are not tracked. Further, if the user consents to being tracked, but not to information being shared, the partner system 104 will refrain from forwarding tracked user data to the principal's server system 102. If the user does provide the requested consent, the user may be persistently reminded of the tracking and/or sharing, and given the opportunity to withdraw his consent, e.g., in a login screen or other portion of a website display sent by the partner system 104, or by periodically (e.g., weekly or monthly) sent electronic notifications or messages.

At 210, the partner system 104 provides the end user with access to its e-commerce platform, into which the inventory feed received from the principal's server system 102 is integrated. Via one or more request-response exchanges at 210, 212, the user can browse the platform, search for particular items, and/or purchase listed items (which may be digital or physical goods, services, viewing options, etc.), regardless of whether they originate from the codeshare principal or are part of the partner's own inventory (or a party, other than the codeshare principal, listing within the partner's platform). Assuming the requisite user consent has been given at 208, the partner system 104 may track all these interactions, aggregate them, and, at 214, pass them on as user behavioral data, along with a unique user identifier (user ID), to the server system 102. In addition to the user behavioral data of an individual user, the partner system 104 may also send partner behavioral data (along with the partner's code sharing ID) to the server system 102 at 214. Certain request received from the user may trigger the partner system 104 to send a corresponding request, along with the user ID and code sharing ID, to the server system 102 at 216. Such requests may include, e.g., a purchase request for items available from the codeshare principal, in response to which the server system 102 implements a phase of a transaction for the item, or s search request, to which the server system 102 may respond with search results tailored based on the user and/or partner behavioral data at 218, The user and partner behavioral data may also serve to update the inventory feed, e.g., to conform it to the evolving needs and preferences of the partner's customer base.

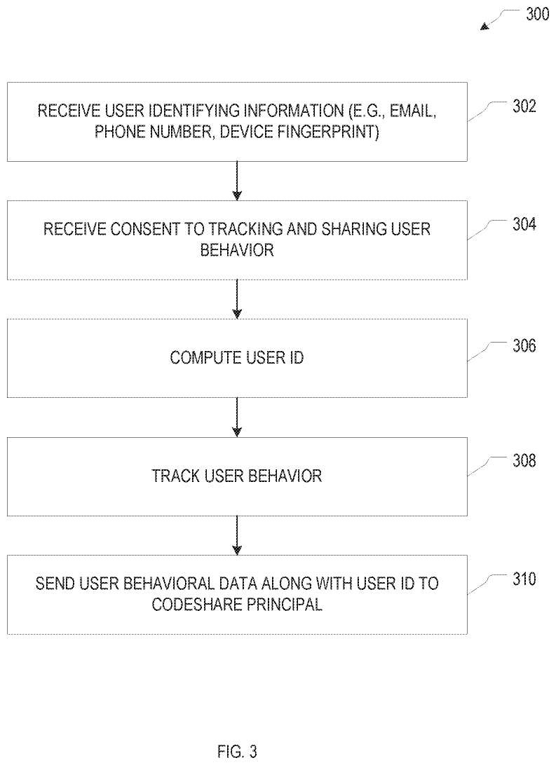

FIG. 3 is a flow chart depicting various acts of a method 300 performed by the codeshare partner in furtherance of providing user behavioral data to the codeshare principal, in accordance with various embodiments. The method 300 involves receiving, from the user, identifying information, such as an email address or telephone number (act 302), as well as consent to tracking the user's behavior on the website (or within some other platform) and sharing user data with the codeshare principal (act 304). As discussed above, the user's information and consent may be obtained as part of a registration process. It is, however, also possible that the user provides the information, and consent to share some user-specific data, during a guest-check-out process that does not require registration.

Following receipt of the user's consent, the partner system 104 generates a unique user ID (act 306). The user ID may be based, e.g., on the user's email address or telephone number, or some other combination of information that is likely unique to the particular user (e.g., the user's name in conjunction with his mailing address). In some embodiments, the user ID is based on a device fingerprint of, and thus tied to, the particular client device 106 with which the user accesses the partner system 104. The device fingerprint may include, e.g., a media access control (MAC) or internet protocol (IP) address of the client device 106, the device serial number, or some unique combination of the device type and model (e.g., iPhone 8), a device description, detail of one or more applications installed on the device, device settings and/or configurations (e.g., a TCP/IP configuration, operating-system fingerprint, clock skew, etc.), or other classifiable or identifiable features. Methods for computing device fingerprints are generally known to those of ordinary skill in the art.

The user 11D serves, in accordance herewith, to identify a given user to the codeshare principal consistently across transactions, allowing the principal to aggregate user data for the user. Identifying the user does, in this context, not necessarily mean that the user's real-world identify is revealed to the principal. In some embodiments, to the contrary, the user ID is some encoding, such as a hash, of the information (e.g., email address or device fingerprint) on which it is based. In this manner, the user's privacy can be protected, while, at the same time, consistent use of the same encoding algorithm ensures that the user ID computed for a given user is always the same. In some embodiments, the algorithm by which the partner systems 104 compute user IDs is prescribed by the codeshare principal, and is consistent across different partners. As a result, user IDs will be consistent not only across transactions, but also across partners, allowing the principal to associate data received from different partners, but for the same user, with the same user data record or user profile. Note that prescribing the encoding algorithm does not necessarily enable the codeshare principal to decode the user ID. Hash functions, for example, may be practically non-invertible, such that the argument (e.g., an email address) cannot be reconstructed from the hash value.

With renewed reference to FIG. 3, the partner system 104 tracks the user's behavior on the partner platform (e.g., the partner site) and/or beyond (act 308). Tracked behavioral data may include, e.g., click data (i.e., which item-listings or, more generally, web-page elements the user clicks on), broader browsing data (e.g., which pages or item listings the user views, and for how long, as may be gleaned, for instance, from tracked mouse-overs, scroll-throughs, etc.), purchase data (including, e.g., a list of purchased items and associated prices, total spending over a specified period, average spending per month or over some specified duration, fluctuations in spending over time, a break-down of purchased items by category, time of purchase, etc.), and combinations thereof (e.g., correlations between views of item listings and any resulting purchases). User behavioral data may also include data unrelated to interactions with the partner platform, such as usage of unrelated applications on the client device 106, user telemetry data such as, e.g., the user's location as determined from global positioning system (GPS) data (or other data obtained using physical sensors of the client device 106), communication patterns (e.g., the frequency of text message exchanges with the user's contacts), and others. The collection and analysis of such data may allow inferences about demographic characteristics (e.g., age, gender, income bracket, etc.), personal preferences (e.g., product types the user is most interested in), and routines/schedules (e.g., time spent online or off-line, time spent in transit as determined from GPS data) of the user. For example, the type of clothes a user browses may allow the user's gender to be determined, a user's regular purchase of toddler toys may indicate that the user has young children, book purchases may reveal the user's education level, and transitions between two locations that occur regularly in the morning and early-evening hours on weekdays may allow an inference that the user is employed. In accordance herewith, the benefit of such information is passed on to the codeshare principal when the partner, in act 310, sends the user behavioral data, along with the associated user ID, to the principal.

Turning now to FIG. 4, the transactional flow of a two-buyer transaction in accordance with various embodiments is illustrated. The transaction involves the codeshare principal 400, the codeshare partner 402, and the end customer 404. It is assumed, as a starting point, that the codeshare principal 400 has shared at least a portion of its inventory via an inventory feed from the server system 102 to the partner system 104 (at 410), and that the partner system 104 provides a combined inventory (including the listings from the shared inventory portion) to the end customer's client device 106 (at 412). It is further assumed, for purposes of the illustrated example, that the contractual arrangement between the code-sharing parties is a “free-flow” codeshare, in which the partner buys from the principal on-demand in response to a purchase request from one of its users rather than purchasing some portion of the inventory upfront (as is the case in so-called block-space codeshare arrangements).

The transaction is initiated when the end customer 404, using the client device 106, selects an item from the codeshare principal's inventory for purchase and begins the check-out process (at 414). In response to this indication that the user wants to purchase the selected item (as reflected in a message from the user that specifies the item identifier), the partner system 104 may, optionally, transmit an inventory check including the item identifier to the server system 102 (at 416), to which the server system 102 may respond with a lock status indicating whether or not the item is still available. As will be appreciated, such an inventory check is generally superfluous if the server system 102 sends real-time (or near real-time) inventory-feed updates to the partner system, allowing the partner system 104 to remove depleted inventory from its listings. If the server system 102 confirms (at 418) that the item is available (or if the partner system 104 had an up-to-date inventory), the transaction can proceed.

At 420, the partner system 104 requests payment and shipping information from the customer 404. The customer 404 provides the requested information at 422, thereby paying for the item. Although not explicitly shown, payment may be facilitated and processed by a third-party payment service, such as a credit card company or online payment system. Upon processing of the customer's payment, the partner system 104 sends a purchase request for the item (specified by its associated item identifier) to the server system 102 (at 424). The purchase request also includes the customer's user ID and the partner's code sharing ID, which allows the server system 102 to record the transaction in respective user and/or partner data records. The partner system 104 further transmits payment for the item at 426. Again, payment may be facilitated via a third-party payment service, although the codeshare principal and partner may also establish more direct payment channels in view of large numbers of transactions they may engage in. Once payment for the item is made, the server system 102 sends an order confirmation to the partner system 104 (at 428), and the partner system 104, in turn, sends an order confirmation to the client device 106 (at 430). The server system 102 also arranges for shipment of the item, e.g., by sending a message internally to the principal's shipping department if the item is held in physical inventory of the principal 400, and otherwise to an external seller, as the case may be. The item is shipped (from the principal 400 or a third-party seller) to the codeshare partner (at 432), and then forwarded by the codeshare partner to the end customer 404 (at 434).

Although the described transaction includes two interleaved transactional stages—a transaction stage 440 in which the partner 402 acts as a buyer purchasing from the principal 400, and a transactional stage 442 in which the partner 402 acts as (re-)seller of the purchased item to the end customer—the end customer 404 may be oblivious to the former stage, and thus experience only one transaction. From the codeshare principal's perspective, there are two buyers associated with the transaction: the partner 402 and the end customer 404.

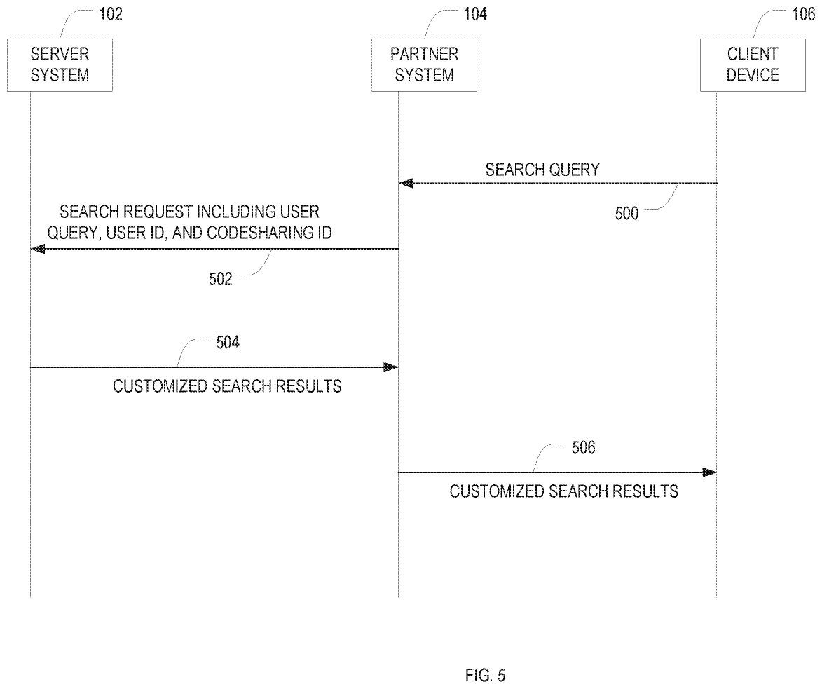

FIG. 5 depicts a partner-mediated informational flow between a codeshare principal and an end customer in accordance with various embodiments, providing an example of the principal enhancing the end user's experience on the partner's platform. In this flow, the client device sends a search query to the partner system (at 500). The partner system 104 formulates and sends a corresponding search request to the server system 102 (at 502). The request includes the query criteria included in the end user's request (e.g., one or more search terms specifying the type of product or service the user is looking for, and/or other criteria, such as a date by which the user needs the item delivered, an acceptable price range, etc.). In addition, the search request to the server system 102 includes the user ID) of the end user and the code sharing ID of the partner. The server system 102 uses this information to identify listings that not only satisfy the user query criteria, but are also customized to the user and/or partner. The server system 102 may, for instance, first retrieve item listings responsive to the query, and then filter the listings based on user and partner data records associated with the identifiers contained in the request. The filtering may, for instance, take user preferences as determined from the user's past browsing and/or purchase behavior into account, and/or may limit the items to one or more categories that the partner wishes to add to its own inventory. The filtered listings are returned to the partner system 104 and forwarded to the client device 106 as customized search results (at 504, 506).

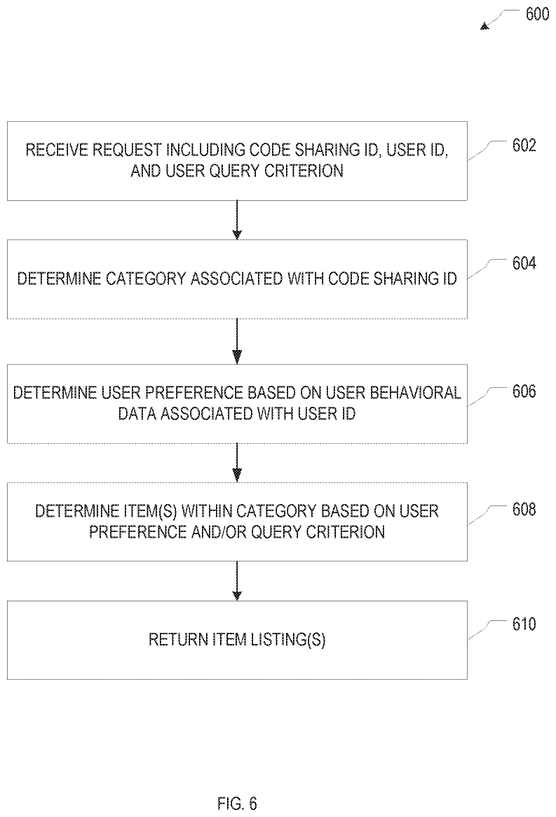

FIG. 6 is a flow chart of one example method 600 performed by a codeshare principal's server system 102 in tailoring its response to a request based on user preferences, in accordance with various embodiments. The method 600 begins, in act 602, with the receipt of a request, e.g., from a codeshare partner's system 104, that includes a code sharing 11D (e.g., the ID associated with that partner), a user ID (e.g., the ID associated with a user on behalf of whom the partner sent the request), and one or more user query criteria (e.g., as provided by the user to the partner system 104). The server system determines, in act 604, a category associated with the code sharing ID. The category may be, e.g., a category or sub-category within a product taxonomy (e.g., vehicles, computers, mobile phone chargers), a particular brand that possibly covers multiple product categories (e.g., Apple™, which may refer, e.g., to Macintosh™ computers or iPhones™), or a group of products defined by some other set of criteria (e.g., release within the last year, manufacturing in a certain country, standard compliance, and so on). In some embodiments, the category (or categories) associated with the code sharing ID specifies the kinds of product listings that the partner would like to get from the principal for inclusion into its own site or platform.

From the user ID specified in the request, the server system 102 determines user preferences, e.g., by looking up and analyzing user behavioral data stored in association with the user ID (act 606). The system then identifies, in, for example, its item listings database 110, one or more items that satisfy the user preference and meet the user query criteria, and that moreover fall within the determined category (act 608). In some embodiments, this act is a two-step process in which items are first identified based on the preference associated with the user identifier and the user query criterion or criteria, regardless of category, and an item within the category is then selected from the identified items. For example, if at least two items match the user query criteria and general user preferences, and if further, at least one of the two or more items is associated with the category and at least one of the two items is not associated with the category, one or more item(s) associated with the category may be selected. The selected item listing(s) are then returned as the search results (act 610). In some embodiments, the results are ranked based on the code sharing identifier, the user identifier, the user query criteria, or any combination thereof.

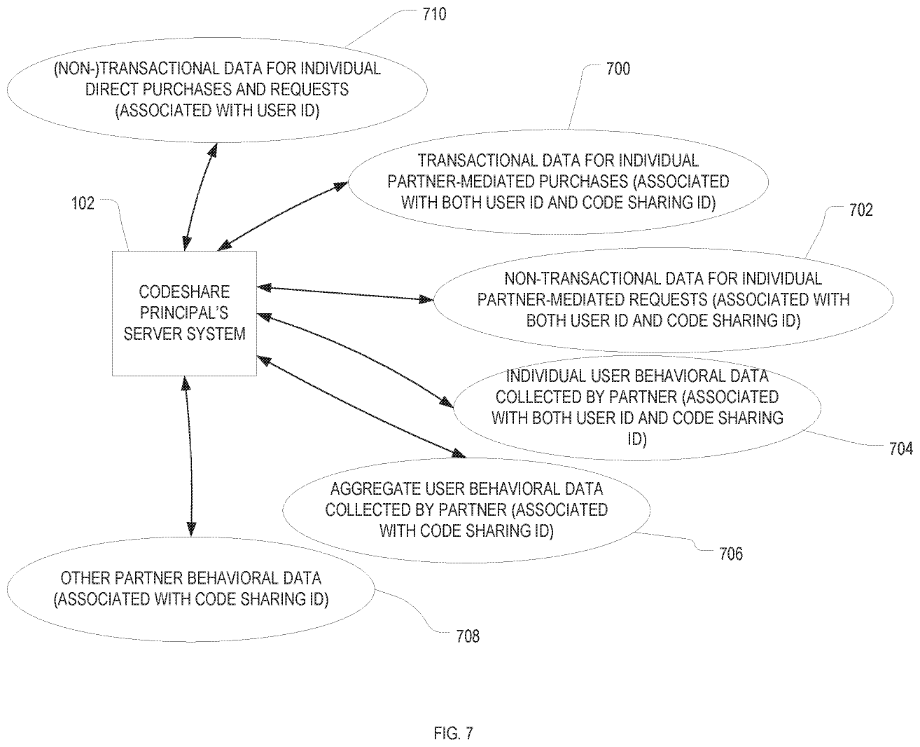

FIG. 7 is a schematic diagram illustrating various sources of user and partner behavioral data as can be used by a codeshare principal to tailor its responses to requests. As shown, transactional data for individual purchases mediated by a partner (700), e.g., as illustrated in FIG. 4, constitute one source of information. The transactional data may include, e.g., a description and price of the purchased item, or other information known to the principal's system from the action itself (and not requiring further data from the partner), and since it is associated with both a user ID and a code sharing ID, it can form part of both user behavioral data and partner behavioral data. Non-transactional data for individual partner-mediated requests (702), that is, pure information requests (e.g., search requests or requests for recommendations) that are not part of a purchase, as illustrated in FIG. 5, provide another source of information to the codeshare principal, and likewise form part of both user behavioral data and partner behavioral data. A third category of information associated with both a user and a partner is individual user behavioral data collected by the partner (704), which includes information about transactions and requests that do not pertain to the principal's inventory and of which the principal would, therefore, not have any knowledge but for the data feeds from the partner pursuant to the codeshare agreement. The user behavioral data may include browsing and/or purchasing histories resulting from aggregating transactions and requests over time, as well as other information (e.g., telemetry data) described above with respect to FIG. 3.

The partner may also aggregate user behavioral data over its customer base to obtain statistical information (706), such as average user spending, number of views and associated conversion rates for various listings or types/categories of products, and similar metrics. Inasmuch as such information is associated with a particular codeshare partner, but not with a particular user, it can be regarded partner behavioral data rather than user behavioral data. Partner behavioral data may also include, as another type 708, data that is unrelated to user behavior on the partner's platform, and instead captures the activities of the partner itself. Examples include information about the way in which the partner integrates the principal's inventory (e.g., the fraction of listings on the partner platform that come from the principal's inventory, the location, size, and other display attributes of the principal's listings) and metrics for the partner's efficiency in marketing the principal's offering (e.g., total sales volume for the principal's products).

On the other end of the spectrum, the codeshare principal may also obtain user behavioral data based on direct transactions with and (non-transactional) requests from users (710). If user IDs are consistently assigned, user behavioral data may be aggregated across transactions/requests (e.g., involving a single codeshare partner as intermediary), across multiple partners (e.g., multiple websites through which the user purchases products), as well as across partner-mediated and direct transactions/requests, resulting in a comprehensive user data record associated with a unique user.

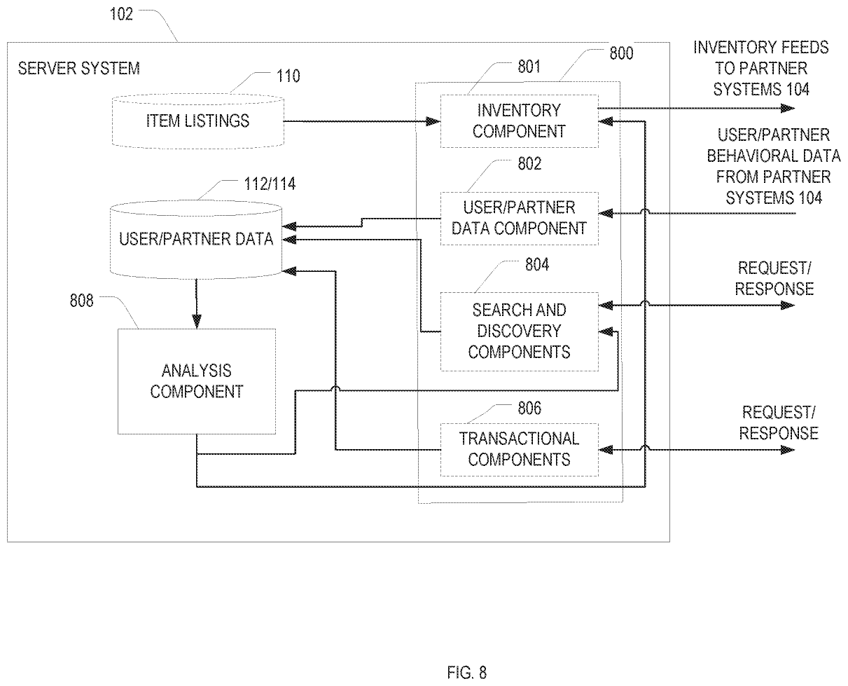

With reference now to FIG. 8, various components of a server system 102 providing the functionality described herein are illustrated. The server system 102 may include a code sharing component 800 through which the system 102 interacts with partner systems 104. The code sharing component 800 may include a communication (e.g., web site) component that communicates with a partner platform (e.g., the partner site). Equally, the code sharing component 800 may include or interact with other components that perform operations to provide functionality to the partner platform. For example, a code sharing component 800 may include, or interact with, an inventory component 801 that pulls listings from the item listings database 110 and provides inventory feeds to the partner systems 104, a user/partner data component 802 that receives user/partner behavioral data from the partner systems 104 and processes the data as needed for storage in the user and partner databases 112, 114, one or more search/discovery components that provide search results, recommendations, and the like to the partner systems 104 in response to requests and write related information to the user/partner databases 112, 114, and one or more transactional components that handle transactional request/response interactions (including, e.g., payment and shipment logistics) with the partner systems 104 and store the transactional information in the user/partner databases 112, 114. The server system 102 may also include an analysis component 808 that may analyze the user and partner data records in the user/partner databases 112, 114 individually or collectively/statistically, and, based on the analysis, provide inputs that control the operation of the inventory component (e.g., by causing inventory feed adjustments) and the search/discovery components 804 (e.g., by tailoring results). The analysis component 808 may, for instance, discover buyer behavioral trends correlated with buyer characteristics discernible from multiple user data records taken in conjunction. It is to be appreciated that the code sharing component 800 may include or interact with other components for other web applications; for example, in the case of a digital media site, it may focus on restricting content to a genre of interest. In the case of a search site, it may restrict search results to a partner site based on geography of the user.

FIG. 9 shows a diagrammatic representation of a machine 900 in the example form of a computer system within which instructions 916 (e.g., software, a program, an application, an applet, an app, or other executable code) for causing the machine 900 to perform any one or more of the methodologies discussed herein may be executed. The machine 900 may, for example, implement any of the server system 102, partner systems 104, or client devices 106. The instructions 916 may cause the machine 900 to execute any of the methods illustrated in the preceding figures. The instructions 916 transform the general, non-programmed machine into a particular machine programmed to carry out the described and illustrated functions in the manner described. By way of example only, dash-dotted boxes indicate the machine 900 as implementing the server system 102.

In various embodiments, the machine 900 operates within a network through which it is connected to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, or other computer capable for use as any of the actors within the monitoring system described herein. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other such as via a bus 902. In an example embodiment, the processors 910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 912 and processor 914 that may execute instructions 916. The term “processor” is intended to include multi-core processor that may comprise two or more independent processors (sometimes referred to as “cores”) that may execute instructions contemporaneously. Although FIG. 9 shows multiple processors 910, the machine 900 may include a single processor with a single core, a single processor with multiple cores (e.g., a multi-core process), multiple processors with a single core, multiple processors with multiples cores, or any combination thereof.

The memory/storage 930 may include a memory 932, such as a main memory, or other memory storage, and a storage unit 936, both accessible to the processors 910 such as via the bus 902. The storage unit 936 and memory 932 store the instructions 916 embodying any one or more of the methodologies or functions described herein. The instructions 916 may also reside, completely or partially, within the memory 932, within the storage unit 936, within at least one of the processors 910 (e.g., within the processor's cache memory), or any suitable combination thereof, during execution thereof by the machine 900. Accordingly, the memory 932, the storage unit 936, and the memory of processors 910 are examples of machine-readable media. When configured as the server system 102, the memory 932 and/or storage unit 936 may, for instance, store the item listings database and user/partner databases 112, 114, as well as instructions implementing the code-sharing component 800.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 916. The term “machine-readable medium” shall also be taken to include any medium, or combination of multiple media, that is capable of storing instructions (e.g., instructions 916) for execution by a machine (e.g., machine 900), such that the instructions, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se. The terms “client” and “server” each refer to one or more computers—for example, a “server” may be a cluster of server machines.

The I/O components 950 may include a wide variety of components to receive input, provide output, produce output, transmit information, exchange information, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. In various example embodiments, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 950 may include communication components 964 operable to couple the machine 900 to a network 980 or devices 970 via coupling 982 and coupling 972 respectively. For example, the communication components 964 may include a network interface component or other suitable device to interface with the network 980. In further examples, communication components 964 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a Universal Serial Bus (USB)).

In various example embodiments, one or more portions of the network 980 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network and the coupling 982 may be a Code Division Multiple Access (CDMA) connection, a Global System for Mobile communications (GSM) connection, or other type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., hypertext transfer protocol (HTTP)). Similarly, the instructions 916 may be transmitted or received using a transmission medium via the coupling 972 (e.g., a peer-to-peer coupling) to devices 970. The term “transmission medium” shall be taken to include any intangible medium that is capable of storing, encoding, or carrying instructions 916 for execution by the machine 900, and includes digital or analog communications signals or other intangible medium to facilitate communication of such software.

The following numbered examples are illustrative embodiments of the disclosed subject matter.

1. A method performed by a server system, the method comprising: receiving a request, the request comprising a code sharing identifier associated with a partner, a user identifier, and a user query criterion; and, in response to the request: determining a category associated with the code sharing identifier; determining an item within the category based on a preference associated with the user identifier and the user query criterion; and returning the item in a response to the request.

2. The method of example 1, wherein determining an item within the category based on a preference associated with the user identifier and the user query criterion comprises determining two or more items based on the preference associated with the user identifier and the user query criterion, at least one of the two or more items being associated with the category and at least one of the two or more items not being associated with the category, and selecting, among the two or more items, an item associated with the category.

3. The method of example 1 or example 2, wherein the response comprises a ranking or recommendation of one or more items based on the code sharing identifier.

4. The method of any of examples 1-3, wherein the response comprises a ranking or recommendation of one or more items based on both the code sharing identifier and the user identifier.

5. The method of any of examples 1-4, further comprising receiving, prior to the request, a call that includes user behavioral data about a user associated with the user identifier, the user behavioral data collected at a partner platform associated with the code sharing identifier, wherein the preference associated with the user identifier is based at least in part on the user behavioral data.

6. The method of example 5, wherein the user behavioral data includes any one of: user click data, user telemetry data, or user browse data on a partner site.

7. The method of any of examples 1-6, further comprising receiving, prior to the request, a call that includes partner behavioral data about the partner associated with the code sharing identifier, wherein the item within the category is determined further based on the partner behavioral data.

8. The method of example 7, wherein the partner behavioral data includes any one of: aggregate behavioral data about multiple users on a partner platform, marketing data about a presentation of items received by the partner from the server system on the partner platform, or partner sales data for items within the category and for items outside the category.

9. The method of any of examples 1-8, wherein the user identifier is based on a device fingerprint of a device, and the device fingerprint includes a device description and detail of an application installed on the device.

10. The method of any of examples 1-9, wherein the user identifier comprises an encoding of at least one of an email address of a user associated with the user identifier, a phone number of the user, or a device fingerprint of a device, and wherein the encoding comprises a hash of the at least one of an email address of the user, a phone number of the user, or a device fingerprint.

11. The method of any of examples 1-10, wherein the code sharing identifier is based on a device fingerprint from a partner system.

12. A server comprising: one or more hardware processors; and one or more computer-readable media storing instructions that cause the processor to perform operations comprising: receiving a request, the request comprising a code sharing identifier associated with a partner, a user identifier, and a user query criterion; and, in response to the request: determining a category associated with the code sharing identifier; determining an item within the category based on a preference associated with the user identifier and the user query criterion; and returning the item in a response to the request.

13. The server of example 12, wherein determining an item within the category based on a preference associated with the user identifier and the user query criterion comprises determining two or more items based on the preference associated with the user identifier and the user query criterion, at least one of the two or more items being associated with the category and at least one of the two or more items not being associated with the category, and selecting, among the two or more items, an item associated with the category.

14. The server of example 12 or example 13, wherein the operations further comprise receiving, prior to the request, a call that includes user behavioral data about a user associated with the user identifier, the user behavioral data collected at a partner site associated with the code sharing identifier, wherein the preference associated with the user identifier is based at least in part on the user behavioral data.

15. The server of example 14, wherein the user behavioral data includes any one of: user click data, user telemetry data, or user browse data on a partner site.

16. The server of any of examples 12-15, wherein the operations further comprise receiving, prior to the request, a call that includes partner behavioral data about the partner associated with the code sharing identifier, wherein the item within the category is determined further based on the partner behavioral data.

17. The server of example 16, wherein the partner behavioral data includes any one of: aggregate behavioral data about multiple users on a partner platform, marketing data about a presentation of items received by the partner from the server system on the partner platform, or partner sales data for items within the category and for items outside the category.

18. The server of any of examples 12-17, wherein the user identifier is based on a device fingerprint of a device, and the device fingerprint includes a device description and detail of an application installed on the device.

19. The server of any of examples 12-18, wherein the user identifier comprises an encoding of at least one of an email address of a user associated with the user identifier, a phone number of the user, or a device fingerprint of a device.

20. One or more computer-readable media storing instruction which, when executed by one or more hardware processors of a machine, cause the machine to perform operations comprising: receiving a request, the request comprising a code sharing identifier associated with a partner, a user identifier, and a user query criterion; and, in response to the request: determining a category associated with the code sharing identifier; determining an item within the category based on a preference associated with the user identifier and the user query criterion; and returning the item in a response to the request.

Although the inventive subject matter has been described with reference to specific example embodiments, it will be evident that various modifications and changes may be made to these embodiments without departing from the broader scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method performed by a server system, the method comprising:
receiving a request, the request comprising a code sharing identifier associated with a partner, a user identifier, and a user query criterion; and
in response to the request:
determining a category associated with the code sharing identifier;
determining an item within the category based on a preference associated with the user identifier and the user query criterion; and
returning the item in a response to the request.

2. The method of claim 1, wherein determining an item within the category based on a preference associated with the user identifier and the user query criterion comprises determining two or more items based on the preference associated with the user identifier and the user query criterion, at least one of the two or more items being associated with the category and at least one of the two or more items not being associated with the category, and selecting, among the two or more items, an item associated with the category.

3. The method of claim 1, wherein the response comprises a ranking or recommendation of one or more items based on the code sharing identifier.

4. The method of claim 1, wherein the response comprises a ranking or recommendation of one or more items based on both the code sharing identifier and the user identifier.

5. The method of claim 1, further comprising receiving, prior to the request, a call that includes user behavioral data about a user associated with the user identifier, the user behavioral data collected at a partner platform associated with the code sharing identifier, wherein the preference associated with the user identifier is based at least in part on the user behavioral data.

6. The method of claim 5, wherein the user behavioral data includes any one of: user click data, user telemetry data, or user browse data on a partner site.

7. The method of claim 1, further comprising receiving, prior to the request, a call that includes partner behavioral data about the partner associated with the code sharing identifier, wherein the item within the category is determined further based on the partner behavioral data.

8. The method of claim 7, wherein the partner behavioral data includes any one of aggregate behavioral data about multiple users on a partner platform, marketing data about a presentation of items received by the partner from the server system on the partner platform, or partner sales data for items within the category and for items outside the category.

9. The method of claim 1, wherein the user identifier is based on a device fingerprint of a device, and the device fingerprint includes a device description and detail of an application installed on the device.

10. The method of claim 1, wherein the user identifier comprises an encoding of at least one of an email address of a user associated with the user identifier, a phone number of the user, or a device fingerprint of a device, and wherein the encoding comprises a hash of the at least one of an email address of the user, a phone number of the user, or a device fingerprint.

11. The method of claim 1, wherein the code sharing identifier is based on a device fingerprint from a partner system.

12. A server comprising:
one or more hardware processors; and
one or more computer-readable media storing instructions that cause the processor to perform operations comprising:
receiving a request, the request comprising a code sharing identifier associated with a partner, a user identifier, and a user query criterion; and
in response to the request:
determining a category associated with the code sharing identifier;
determining an item within the category based on a preference associated with the user identifier and the user query criterion; and
returning the item in a response to the request.

13. The server of claim 12, wherein determining an item within the category based on a preference associated with the user identifier and the user query criterion comprises determining two or more items based on the preference associated with the user identifier and the user query criterion, at least one of the two or more items being associated with the category and at least one of the two or more items not being associated with the category, and selecting, among the two or more items, an item associated with the category.

14. The server of claim 12, wherein the operations further comprise receiving, prior to the request, a call that includes user behavioral data about a user associated with the user identifier, the user behavioral data collected at a partner platform associated with the code sharing identifier, wherein the preference associated with the user identifier is based at least in part on the user behavioral data.

15. The server of claim 14, wherein the user behavioral data includes any one of: user click data, user telemetry data, or user browse data on a partner site.

16. The server of claim 12, wherein the operations further comprise receiving, prior to the request, a call that includes partner behavioral data about the partner associated with the code sharing identifier, wherein the item within the category is determined further based on the partner behavioral data.

17. The server of claim 16, wherein the partner behavioral data includes any one of aggregate behavioral data about multiple users on a partner platform, marketing data about a presentation of items received by the partner from the server system the partner platform, or partner sales data for items within the category and for items outside the category.

18. The server of claim 12, wherein the user identifier is based on a device fingerprint of a device, and the device fingerprint includes a device description and detail of an application installed on the device.

19. The server of claim 12, wherein the user identifier comprises an encoding of at least one of an email address of a user associated with the user identifier, a phone number of the user, or a device fingerprint of a device.

20. One or more computer-readable media storing instruction which, when executed by one or more hardware processors of a machine, cause the machine to perform operations comprising:
receiving a request, the request comprising a code sharing identifier associated with a partner, a user identifier, and a user query criterion; and
in response to the request:
determining a category associated with the code sharing identifier;
determining an item within the category based on a preference associated with the user identifier and the user query criterion; and
returning the item in a response to the request.
